(19) United States
(12) Patent Application Publication
(10) Pub. No.: US 2026/0259454 A1
(43) Pub. Date: Sep. 3, 2026

(54) FRONT-MOUNTED LIGHT SOURCE AND DISPLAY DEVICE

(71) Applicant: BOE TECHNOLOGY GROUP CO., LTD., Beijing (CN)

(72) Inventors: Yujie Liu, Beijing (CN); Zheng Fang, Beijing (CN); Jiahui Han, Beijing (CN); Yanliu Sun, Beijing (CN); Yutong Yan, Beijing (CN); Weili Zhao, Beijing (CN)

(73) Assignee: BOE TECHNOLOGY GROUP CO., LTD., Beijing (CN)

(21) Appl. No.: 18/702,147

(22) PCT Filed: May 9, 2023
(86) PCT No.: PCT/CN2023/092979

§ 371 Date: Apr. 17, 2024

(30) Foreign Application Priority Data
Jun. 15, 2022 (CN) 202210680967.3

(51) Int. Cl. G02F 1/1335; G02F 1/13363

(52) U.S. Cl. CPC G02F 1/133616; G02F 1/133528; G02F 1/133638

(57) ABSTRACT

A front-mounted light source and a display device are disclosed. The front-mounted light source includes: a base substrate and light-emitting elements on the base substrate. Each light-emitting element includes a light-emitting layer and a reflective layer. The reflective layer is between the light-emitting layer and the base substrate. A side of at least one light-emitting element away from the base substrate is provided with a first quarter-wave plate and a polarizing layer. The polarizing layer is at a side of the first quarter-wave plate away from the light-emitting element and is used for transmitting polarized light of a first polarization direction and reflecting polarized light of a second polarization direction. The first polarization direction intersects the second polarization direction.

### TECHNICAL FIELD

The present invention relates to the technical field of display, and in particular to a front-mounted light source and a display device.

### BACKGROUND

Reflective display devices include, for example, a reflective liquid crystal display device or an electronic paper display device or the like. Taking a reflective liquid crystal display device as an example, a display principle thereof is as follows: ambient light outside a reflective display panel or light of a front-mounted light source is reflected back after being incident on the reflective display panel, and ratios of light reflected by each pixel of the reflective display panel are different by controlling deflection states of the liquid crystal molecules, thereby realizing display.

### SUMMARY

The present invention aims to solve at least one of the technical problems existing in the related art, and proposes a front-mounted light source and a display device.

In order to achieve the above object, the present invention provides a front-mounted light source, including: a base substrate and a plurality of light-emitting elements on the base substrate; wherein each of the light-emitting elements includes a light-emitting layer and a reflective layer, and the reflective layer is between the light-emitting layer and the base substrate; a side of at least one light-emitting element away from the base substrate is provided with a first quarter-wave plate and a polarizing layer; the polarizing layer is at a side of the first quarter-wave plate away from the light-emitting element and is used for transmitting polarized light of a first polarization direction and reflecting polarized light of a second polarization direction; and the first polarization direction intersects the second polarization direction.

In some embodiments, the polarizing layer is a wire grid polarizing layer.

In some embodiments, the wire grid polarizing layer includes a plurality of metal wires arranged side by side; an arrangement cycle of the metal wires is between 60 nm and 14 nm; a height of each of the metal wires is between 160 nm and 300 nm; and a ratio of a line width of each of the metal wires to the arrangement cycle of the metal wires is between 0.5 and 0.7.

In some embodiments, the light-emitting layer includes an n-type semiconductor layer, a p-type semiconductor layer and a quantum well layer; the n-type semiconductor layer and the p-type semiconductor layer are both between the quantum well layer and the reflective layer, and the n-type semiconductor layer and the p-type semiconductor layer are both in contact with the quantum well layer;
the first quarter-wave plate is in direct contact with the quantum well layer and the polarizing layer is in direct contact with the first quarter-wave plate.

In some embodiments, the plurality of light-emitting elements are arranged in a plurality of rows in a first direction, each row includes a plurality of light-emitting elements arranged in a second direction; the plurality of light-emitting elements in a same row include a plurality of light-emitting colors, and the light-emitting colors of a plurality of light-emitting elements arranged in the first direction are the same;
the first direction intersects the second direction.

In some embodiments, a spacing between two light-emitting elements adjacent in the first direction is 2 to 4 times a spacing between two adjacent light-emitting elements in a same row.

In some embodiments, the front-mounted light source has a plurality of partitions; a plurality of the light-emitting elements are arranged in each of the partitions; and in a same partition, a plurality of light-emitting elements with a same light-emitting color are connected in parallel.

In some embodiments, in the same partition, the plurality of light-emitting elements are divided into a plurality of light-emitting groups, the plurality of light-emitting groups are arranged side by side in the first direction, each of the light-emitting groups includes a plurality of light-emitting elements arranged in the second direction, and the plurality of light-emitting elements in a same light-emitting group include a plurality of light-emitting colors;

in a same light-emitting group in the same partition, first electrodes of the plurality of light-emitting elements are connected to a same first voltage lead, second electrodes of light-emitting elements of a same color are connected to a same second voltage lead, and second electrodes of light-emitting elements of different colors are connected to different second voltage leads;
in the same partition, the first voltage leads connected to the plurality of light-emitting groups are connected via a first connecting wire; in the second voltage leads connected to the plurality of light-emitting groups, the second voltage leads connected to the light-emitting elements of a same color are connected via a second connecting wire.

In some embodiments, orthographic projections of the first quarter-wave plate and the polarizing layer onto the base substrate are both within an orthographic projection of the light-emitting elements onto the base substrate.

In some embodiments, the polarizing layer is made of aluminum.

One embodiment of the present disclosure further provides a display device, including: a reflective display panel, a polarizer, a second quarter-wave plate and a front-mounted light source according to any one of claims 1 to 10, wherein the front-mounted light source, the second quarter-wave plate and the polarizer are all arranged at a display side of the reflective display panel, the second quarter-wave plate is between the front-mounted light source and the reflective display panel, the polarizer is arranged at a side of the second quarter-wave plate away from the reflective display panel, and a polarization direction of the polarizer is a first polarization direction.

In some embodiments, the polarizer is arranged at a side of the front-mounted light source facing away from the reflective display panel.

In some embodiments, the display device further includes a half-wave plate between the front-mounted light source and the second quarter-wave plate.

In some embodiments, the reflective display panel includes: an array substrate and a counter substrate which are arranged opposite to each other to form a cell therebetween, and a liquid crystal layer located therebetween;
the array substrate includes:
a first base;
a thin-film transistor on a side of the first base facing the liquid crystal layer;
a first insulating layer on a side of the thin-film transistor away from the first base, wherein the first insulating layer is provided with a first via hole corresponding to a drain electrode of the thin-film transistor;
a reflective electrode on a side of the first insulating layer away from the first base, and connected to the drain electrode of the thin-film transistor via the first via hole;
a second insulating layer on a side of the reflective electrode away from the first base, wherein the second insulating layer is provided with a second via hole corresponding to the reflective electrode;
a pixel electrode arranged on a side of the second insulating layer away from the first bas, and connected to the reflective electrode through the second via hole.

In some embodiments, a surface of the reflective electrode remote from the first base is concave-convex.

In some embodiments, the plurality of light-emitting elements are arranged in a plurality of rows in a first direction, each row includes a plurality of light-emitting elements arranged in a second direction; the plurality of light-emitting elements in a same row include a plurality of light-emitting colors, and the light-emitting colors of a plurality of light-emitting elements arranged in the first direction are the same; the first direction intersects the second direction;
a spacing between two light-emitting elements of a same light-emitting color adjacent in the second direction is smaller than a distance between the light-emitting elements and the reflective electrode.

### BRIEF DESCRIPTION OF THE DRAWINGS

The drawings described herein are used to provide a further understanding of the present disclosure and constitute a part of the disclosure. The exemplary embodiments of the disclosure and the descriptions thereof are used to explain the disclosure, and do not constitute improper limitations to the disclosure. In the drawings:

FIG. 1 is a schematic diagram of a display device provided in some embodiments;

FIG. 2 is a graph showing relationship between contrast of a display device and contrast of a reflective display panel when interface reflectivity is of different values;

FIG. 3 is a schematic diagram of a front-mounted light source provided in some embodiments of the present disclosure;

FIG. 4 is a schematic diagram of a light-emitting element provided in some embodiments of the present disclosure;

FIG. 5 is an enlarged view of the Q region in FIG. 3;

FIG. 6 is a graph showing relationship between a polarization degree of a polarizing layer and wavelength when metal wires adopt different arrangement cycles;

FIG. 7 is a graph showing relationship between a polarization degree of a polarizing layer and wavelength when metal wires adopt different heights;

FIG. 8 is a graph showing relationship between a polarization degree of a polarizing layer and wavelength when metal wires adopt different arrangement duty ratios;

FIG. 9 is a graph showing relationship between a polarization degree of a polarizing layer and wavelength when the polarizing layer is made of different materials;

FIG. 10 is a schematic diagram of an arrangement of a plurality of light-emitting elements provided in some embodiments of the present disclosure;

FIG. 11 is a schematic diagram showing connection of light-emitting elements in one partition provided in some embodiments of the present disclosure;

FIG. 12 is a schematic diagram of a drive line layer in a front-mounted light source provided in some embodiments of the present disclosure;

FIGS. 13A-13D are schematic diagrams illustrating fabrication of a front-mounted light source in an embodiment of the present disclosure;

FIG. 14 is a schematic diagram of a display device provided in some embodiments of the present disclosure; and

FIG. 15 is a schematic diagram of a reflective display panel provided in some embodiments of the present disclosure.

### DETAILED DESCRIPTION

Specific embodiments of the present disclosure will be described in detail hereinafter with reference to the accompanying drawings. It is to be understood that the specific embodiments described here are only used to illustrate and explain the present disclosure, and are not intended to limit the present disclosure.

In order to make the purpose, technical solutions and advantages of the embodiments of the present disclosure more clear, the technical solutions of the embodiments of the present disclosure will be clearly and completely described hereinafter in conjunction with the drawings of the embodiments of the present disclosure. Obviously, the described embodiments are only a part of the embodiments of the present disclosure, rather than all of them. Based on the embodiments in the present disclosure, all other embodiments obtained by those of ordinary skill in the art without creative work shall fall within the protection scope of the present disclosure.

Unless otherwise defined, any technical or scientific terms used herein shall have the common meaning understood by a person of ordinary skills. Such words as “first” and “second” used in the present disclosure are merely used to differentiate different components rather than to represent any order, number or importance. Similarly, such words as “including” or “comprising” mean that an element or thing appearing before the word includes elements or things listed after the word and their equivalents, without excluding other elements or things. Such words as “connect”, or “connected to” may include electrical connection, direct or indirect, rather than being limited to physical or mechanical connection. Such words as “on”, “under”, “left” and “right” are merely used to represent relative position relationship, and when an absolute position of an object is changed, the relative position relationship will be changed too.

FIG. 1 is a schematic view of a display device provided in some embodiments. As shown in FIG. 1, the display device is a reflective display device and includes: a reflective display panel, a front-mounted light source 10, a polarizer 20 and a quarter-wave plate 30. The front-mounted light source 10 is disposed at a display side of the reflective display panel. The front-mounted light source 10 includes a base substrate 11 and a light-emitting element 12 on the base substrate 11. The polarizer 20 is arranged between the front-mounted light source 10 and the reflective display panel. The quarter-wave plate 30 is arranged between the reflective display panel and the polarizer 20. The reflective display panel includes: an array substrate 40 and a counter substrate 50, which are oppositely arranged with each other to form a cell, and a liquid crystal layer 60 located therebetween. The array substrate 40 includes a plurality of pixels, and a reflective electrode 41 is arranged in each pixel.

Taking the reflective display panel being in a normally-white mode as an example, the display principle of the display device in FIG. 1 is described below. In a normally-white mode reflective display panel, when the liquid crystal layer 60 is not powered, the phase modulation effect on light is equivalent to the effect of the quarter-wave plate 30.

When achieving a bright-state display, light rays (natural light) of the light-emitting element 12 pass through the polarizer 20 to form first linearly polarized light; the first linearly polarized light passes through the quarter-wave plate 30 to form circularly polarized light; and after passing through the liquid crystal layer 60, the circularly polarized light becomes second linearly polarized light; and a polarization direction of the second linearly polarized light is perpendicular to a first polarization direction. After the second linearly polarized light is reflected by the reflective electrode 41, the polarization direction does not change, and the reflected light passes through the liquid crystal layer 60 and the quarter-wave plate 30 and then becomes third linearly polarized light; and a polarization direction of the third linearly polarized light is the same as the polarization direction of the first linearly polarized light, and thus the third linearly polarized light can be emitted through the polarizer 20, so that the reflective display device displays a white image.

When achieving a dark-state display, a voltage is applied to the liquid crystal layer 60 so that it has no effect on the phase of the light. Meanwhile, the light (natural light) of the light-emitting element 12 passes through the polarizer 20 to form first linearly polarized light; the first linearly polarized light passes through the quarter-wave plate 30 to form circularly polarized light; the polarization direction of the circularly polarized light does not change after passing through the liquid crystal layer 60 and after being reflected by the reflective electrode 41; and then the circularly polarized light passes through the quarter-wave plate 30 to form second linearly polarized light; the polarization direction of the second linearly polarized light is perpendicular to the polarization direction of the first linearly polarized light, and thus the second linearly polarized light cannot be emitted from the polarizer 20, so that the reflective display device displays a black image.

When achieving an intermediate-state display (i.e., displaying a grayscale image between a white image and a black image), a voltage is applied to the liquid crystal layer 60 so that a certain deflection occurs. At this time, light (natural light) of the light-emitting element 12 passes through the polarizer 20 so as to form a first linearly polarized light; and the first linearly polarized light passes through the quarter-wave plate 30 so as to form an elliptically polarized light. Taking the elliptically polarized light being a left-handed elliptically polarized light as an example, the left-handed elliptically polarized light is reflected by the reflective electrode 41 and then becomes a right-handed elliptically polarized light. The right-handed elliptically polarized light passes through the liquid crystal layer 60 and the quarter-wave plate 30 so as to form a fourth linearly polarized light. An angle between the polarization direction of the fourth linearly polarized light and the polarization direction of the first linearly polarized light is greater than 0° and less than 90°. Thus, a part of the light can be emitted through the polarizer 20 to display a gray image.

In the reflective display device shown in FIG. 1, when the light emitted from the front-mounted light source is irradiated to the polarizer 20, only 42% of the light is transmitted and another part of the light is absorbed by the polarizer 20, resulting in a lower light efficiency of the display device.

In addition, the polarizer usually includes a plurality of optical films arranged in a stack, for example, including a triacetate (TAC) film, a pressure sensitive adhesive (PSA) film, an adhesive layer, etc. The optical films of different materials have different refractive indices, which results in that an interface between the optical films of different materials causes a certain reflection of light emitted by a light-emitting element, and usually, the reflectivity of the interface in the polarizing layer is 0.5%, which results in that a part of the light is directly reflected to the human eye without modulation of a liquid crystal layer, thereby resulting in a low contrast ratio (CR) of a display device.

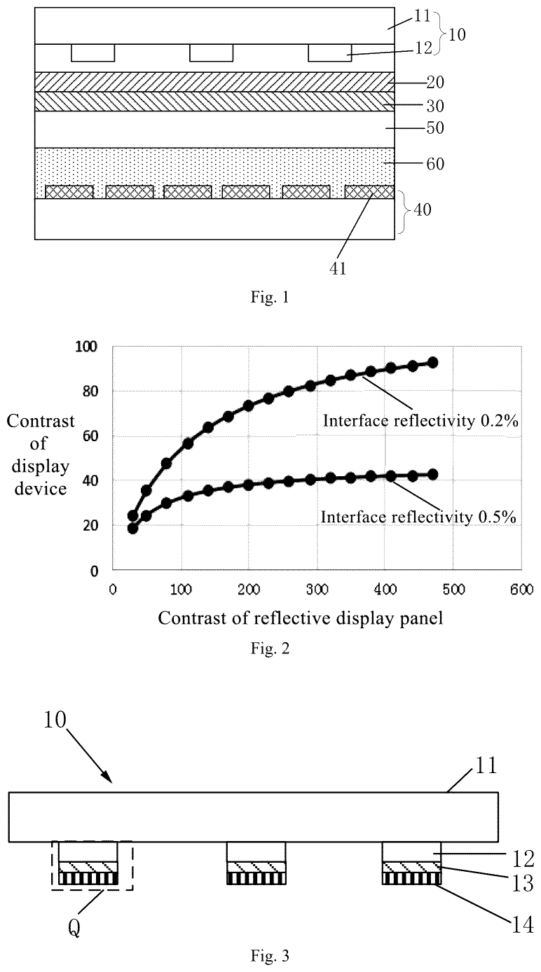

FIG. 2 is a graph showing relationship between contrast of a display device and contrast of a reflective display panel when interface reflectivity is of different values. As shown in FIG. 2, in case that the interface reflectivity in the polarizing layer is 0.2%, when the contrast ratio of the reflective display panel is high, the contrast ratio of the display device is also high. In case that the interface reflectivity in the polarizing layer is 0.5%, when the contrast of the reflective display panel is high, the contrast of the display device does not reach a high value.

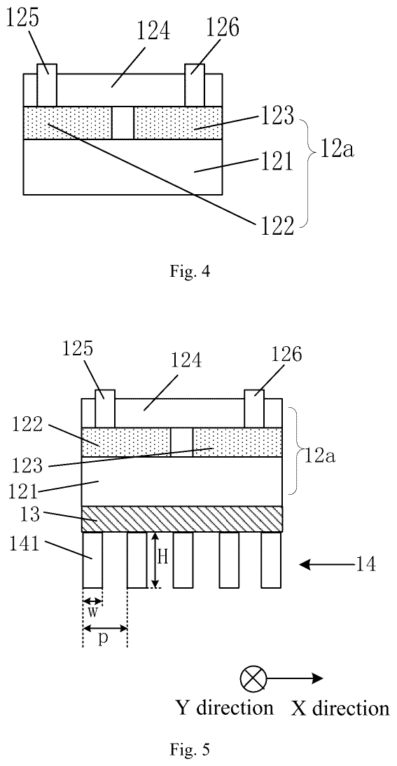

In order to solve at least one of the above technical problems, one embodiment of the present disclosure provides a front-mounted light source for use in a reflective display device. FIG. 3 is a schematic diagram of the front-mounted light source provided in some embodiments of the present disclosure. As shown in FIG. 3, the front-mounted light source 10 includes: a base substrate 11 and a plurality of light-emitting elements 12, such as mini-LED/micro LED, provided on the base substrate 11. FIG. 4 is a schematic diagram of a light-emitting element provided in some embodiments of the present disclosure. As shown in FIG. 4, the light-emitting element 12 may be a flip-chip type light-emitting diode including: a light-emitting layer 12a, a first electrode 125 and a second electrode 126 which are respectively electrically connected to the light-emitting layer 12a. One of the first electrode 125 and the second electrode 126 is a positive electrode, and the other is a negative electrode. The light-emitting layer 12a may include: an n-type semiconductor layer 122, a p-type semiconductor layer 123, and a quantum well layer 121 in contact with the two. Here, the n-type semiconductor layer 122 and the p-type semiconductor layer 123 are located at the same side of the quantum well layer 121, and the n-type semiconductor layer 122 and the p-type semiconductor layer 123 are spaced apart by an insulating layer (not shown). In addition, the light-emitting element 12 further includes a reflective layer 124 positioned between the light-emitting layer 12a and the base substrate 11 so that light emitted from the light-emitting layer 12a can be emitted toward a side away from the base substrate 11 as much as possible. In one example, the reflective layer 124 can include multiple dielectric layers arranged in a stack, which can include a silicon oxide layer, a titanium oxide layer, etc. The first electrode 125 may be electrically connected to the n-type semiconductor layer 122 through a via hole in the reflective layer 124, and the second electrode 126 may be electrically connected to the p-type semiconductor layer 123 through a via hole in the reflective layer 124.

FIG. 5 is an enlarged view of the Q region shown in FIG. 3, and in conjunction with FIGS. 3 to 5, a first quarter-wave plate 13 and a polarizing layer 14 are further provided on a side of at least one light-emitting element 12 away from the base substrate 11. The polarizing layer 14 is located at a side of the first quarter-wave plate (¼ wave plate) 13 away from the light-emitting element 12 for transmitting polarized light of a first polarization direction and reflecting polarized light of a second polarization direction. The first polarization direction crosses the second polarization direction.

In one example, one of the polarized light of the first polarization direction and the polarized light of the second polarization direction is TM light and the other is TE light.

The principle of providing linearly polarized light for a reflective display panel by the front-mounted light source 10 shown in FIG. 3 is that: the natural light emitted by the light-emitting element 12 is still natural light after passing through the first quarter-wave plate 13; when the natural light irradiates the polarizing layer 14, polarized light of the first polarization direction passes through the polarizing layer 14, polarized light of the second polarization direction is reflected by the polarizing layer 14; the reflected light passes through the first quarter-wave plate 13 and becomes circularly polarized light; after the circularly polarized light is reflected by the reflective layer 124, its rotation direction changes, and the circularly polarized light with the changed rotation direction passes through the first quarter-wave plate 13 again and becomes polarized light of the first polarization direction so as to be emitted through the polarizing layer 14. Taking the polarized light of the first polarization direction being TM light as an example, the natural light emitted by the light-emitting element 12 is still natural light after passing through the first quarter-wave plate 13. When the natural light irradiates on the polarizing layer 14, the TM light passes through the polarizing layer 14, and the TE light is reflected by the polarizing layer 14. After passing through the first quarter-wave plate 13, the reflected TE light becomes left-handed circularly polarized light. After being reflected by the reflective layer 124, the left-handed circularly polarized light becomes right-handed circularly polarized light. After passing through the first quarter-wave plate 13 again, the right-handed circularly polarized light becomes TM light so as to be emitted through the polarizing layer 14. It can be seen that after the first quarter-wave plate 13 and the polarizing layer 14 are provided, a part of the light emitted by the light-emitting element 12 directly passes through the polarizing layer 14, and a part of the remaining light passes through the polarizing layer 14 after multiple reflections, so that the light efficiency of the front-mounted light source 10 can be improved.

In some embodiments, as shown in FIG. 5, the polarizing layer 14 is a wire grid polarizing layer 14 that includes a plurality of metal wires 141. The plurality of metal wires 141 may lie in the same plane so that after light from the light-emitting element 12 are emitted from the polarizing layer 14, the light is distributed more evenly.

In some embodiments, the wire grid polarizing layer 14 includes a plurality of metal wires 141 arranged side-by-side in a first direction (X-direction), each metal wire 141 may extend in a second direction (Y-direction). The first direction and the second direction may be perpendicular.

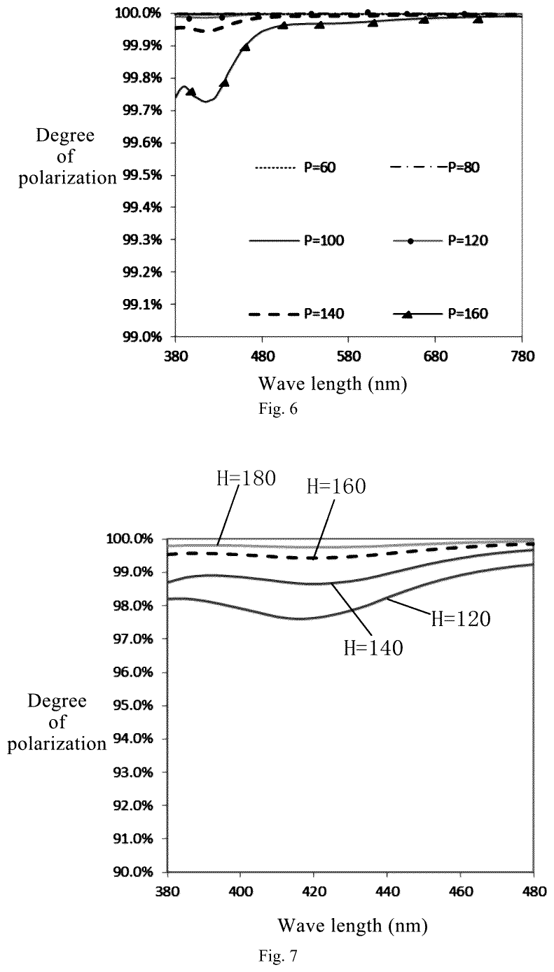

FIG. 6 is a graph showing relationship between a polarization degree of a polarizing layer and wavelength when metal wires adopt different arrangement cycles. As shown in FIG. 6, when the arrangement cycle P of the metal wires 141 is less than or equal to 140 nm, the degree of polarization of the polarizing layer 14 to the full band of visible light is higher; therefore, in some embodiments, setting the arrangement cycle P of the metal wires 141 to be less than or equal to 140 nm is beneficial to improve the degree of polarization of the polarizing layer 14 to the full band of visible light. Considering that the fabrication difficulty increases when the arrangement cycle P of the metal wires 141 is too small, in some preferred embodiments, the arrangement cycle P of the metal wires 141 is set between 60 nm and 140 nm, thereby facilitating the fabrication of the wire grid polarizing layer while increasing the degree of polarization of the polarizing layer 14 to the full band of visible light. For example, the arrangement cycle is set to 60 nm or 80 nm or 100 nm or 120 nm or 140 nm.

FIG. 7 is a graph showing relationship between a polarization degree of a polarizing layer and wavelength when metal wires adopt different heights. As shown in FIG. 7, when the height of the metal wire 141 is greater than or equal to 160 nm, the degree of polarization of the polarizing layer 14 to the ful band of visible light is high. However, when the height of the metal wires 141 is too large, transmittance of the polarizing layer 14 is low, and thus in some preferred embodiments, the height H of the metal wires 141 is set between 160 nm and 300 nm, so as to improve the degree of polarization of the polarizing layer 14 to the full band of visible light while ensuring the transmittance of the polarizing layer 14. For example, the height H is set to 160 nm, or 200 nm or 250 nm or 300 nm.

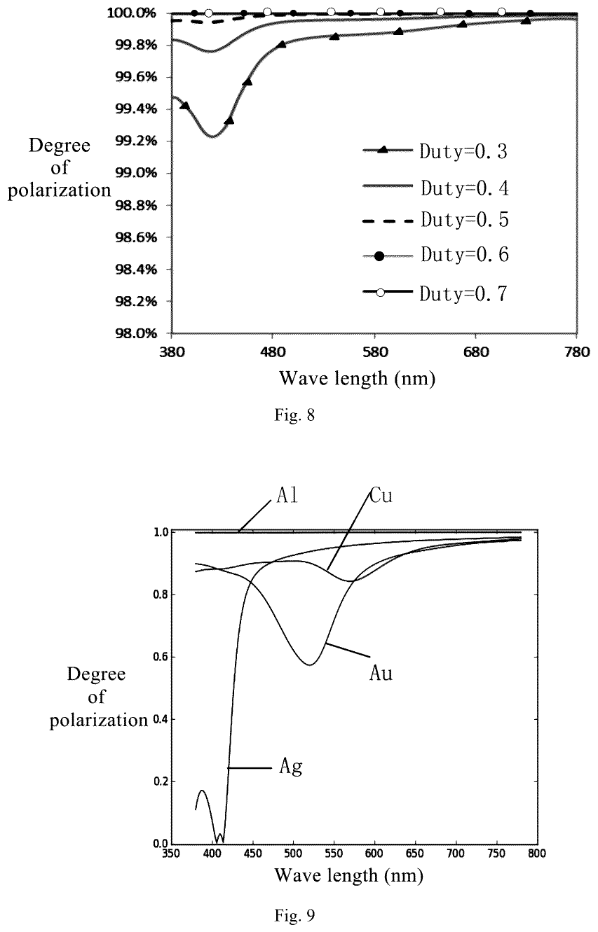

FIG. 8 is a graph showing relationship between a polarization degree of a polarizing layer and wavelength when metal wires adopt different arrangement duty ratios. The arrangement duty ratio is a ratio of a line width w of a metal wire 141 to the arrangement cycle P. As shown in FIG. 8, when the arrangement duty ratio of the metal wires 141 is greater than 0.5, the degree of polarization of the polarizing layer 14 to the full band of visible light is high. Considering that the transmittance of the polarizing layer 14 is low when the arrangement duty ratio of the metal wires 141 is too large, and thus in some embodiments, the arrangement duty ratio (the ratio of the line width w of the metal wires 141 to the arrangement cycle P) of the metal wires 141 is set between 0.5 and 0.7, thereby improving the degree of polarization of the polarizing layer 14 to the full band of visible light while ensuring the transmittance of the polarizing layer 14. For example, the arrangement duty ratio is set to 0.5, or 0.6 or 0.7.

In some embodiments of the present disclosure, the material of the polarizing layer 14 includes aluminum. Herein, the material of the polarizing layer 14 refers to the material of the metal wires 141. FIG. 9 is a graph showing relationship between a polarization degree of a polarizing layer and wavelength when the polarizing layer is made of different materials. As shown in FIG. 9, compared to the polarizing layer 14 made of other materials, the degree of polarization of the polarizing layer 14 made of aluminum to the full band of visible light is higher.

In some embodiments of the present disclosure, the first quarter-wave plate 13 may be in direct contact with the quantum well layer 121 of the light-emitting element, and the polarizing layer 14 may be in direct contact with the first quarter-wave plate 13, thereby improving light efficiency and preventing the metal wires 141 of the polarizing layer 14 from affecting the light emitting angle. Two structures are “in direct contact” means that there is no other structure provided between the two structures.

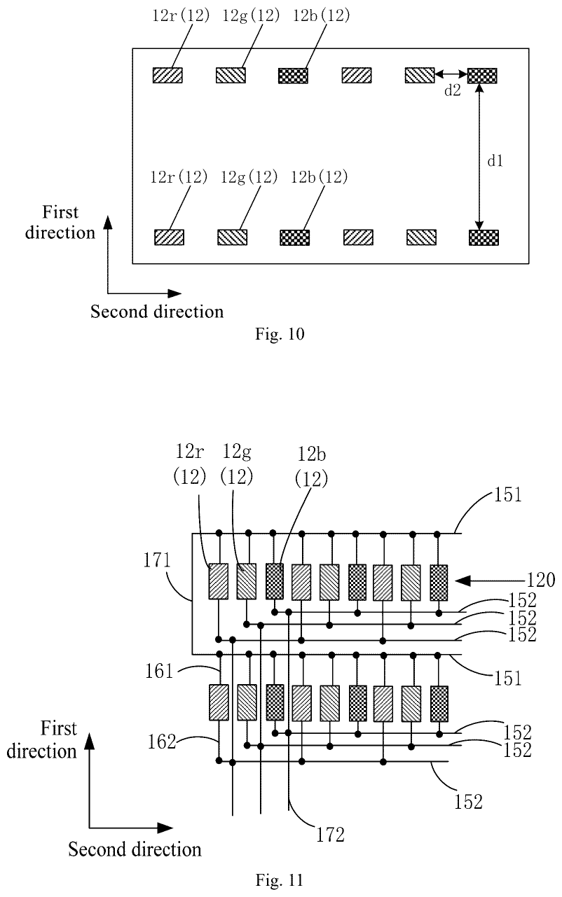

FIG. 10 is a schematic diagram of an arrangement of a plurality of light-emitting elements provided in some embodiments of the present disclosure. As shown in FIG. 10, the light-emitting colors of the plurality of light-emitting elements 12 may include various colors, for example, red, green and blue. When the reflective display device performs display, the front-mounted light source 10 can be driven to emit light in a field sequential driving manner. That is, in each display cycle of the reflective display device, the red light-emitting element 12r, the blue light-emitting element 12b and the green light-emitting element 12g are driven to emit light in sequence, so that the reflective display device sequentially displays a red sub-picture, a blue sub-picture and a green sub-picture in a display cycle. Due to persistence of vision effect of the human eye, the three sub-pictures are mixed in the brain to form an image with a certain color. In this case, each pixel in the display panel does not need to be subdivided into a plurality of sub-pixels of different colors, thereby contributing to an increase in product resolution.

As shown in FIG. 10, the plurality of light-emitting elements 12 may be arranged in an array. Specifically, the plurality of light-emitting elements 12 are arranged in a plurality of rows in a first direction, each row including the plurality of light-emitting elements 12 arranged in a second direction. The first direction intersects the second direction, for example, the first direction is perpendicular to the second direction. The plurality of light-emitting elements 12 in the same row include multiple light-emitting colors, for example, the plurality of light-emitting elements 12 in the same row includes a red light-emitting element 12r, a green light-emitting element 12g and a blue light-emitting element 12b, which respectively emit red light, green light and blue light. The red light-emitting element 12r, the green light-emitting element 12g, and the blue light-emitting element 12b are alternately arranged in the second direction. As shown in FIG. 10, the plurality of light-emitting elements 12 arranged in the same row in the first direction have the same light-emitting color, thereby facilitating the transfer of the plurality of light-emitting elements 12 to the base substrate 11 through the transfer process during the production of the front-mounted light source 10.

In one example, the plurality of light-emitting elements 12 are arranged in a plurality of rows and a plurality of columns, where the first direction is a column direction, and the second direction is a row direction, i.e., the plurality of light-emitting elements 12 in the same row may include a plurality of light-emitting colors, and the light-emitting elements 12 in the same column have the same light-emitting color.

In some embodiments, a spacing d1 between two adjacent light-emitting elements 12 in the first direction is 2 to 4 times a spacing d2 between two adjacent light-emitting elements 12 in the same row in the second direction, thereby facilitating uniform mixing of light from light-emitting elements 12 of different colors. For example, d1 is 2 times, or 3 times, or 4 times of d2.

In some embodiments, the front-mounted light source 10 may be controlled to emit light by means of partition control. The front-mounted light source 10 has a plurality of partitions, and a plurality of light-emitting elements 12 are provided in each partition. FIG. 11 is a schematic diagram showing connection of light-emitting elements in one partition provided in some embodiments of the present disclosure. As shown in FIG. 11, in the same partition, multiple light-emitting elements 12 of the same light-emitting color are connected in parallel. By connecting light-emitting elements 12 of the same light-emitting color in the same partition in parallel, the drive current can be increased to meet the electrical drive requirements of the light-emitting elements 12. In addition, each partition can be independently controlled according to an image to be displayed, thereby facilitating reduction of driving power consumption. For example, when a certain region of an image to be displayed is in a dark state, the light-emitting elements 12 in the corresponding partition may be controlled not to emit light.

In some embodiments, as shown in FIG. 11, in the same partition, the plurality of light-emitting elements 12 are divided into a plurality of light-emitting groups 120; the plurality of light-emitting groups 120 are arranged side by side in the first direction, each light-emitting group 120 includes a plurality of light-emitting elements 12 arranged in the second direction. The plurality of light-emitting elements 12 in the same light-emitting group 120 include a plurality of light-emitting colors, for example, the plurality of light-emitting elements 12 in the same light-emitting group 120 includes a plurality of red light-emitting elements 12r, a plurality of green light-emitting elements 12g and a plurality of blue light-emitting elements 12b.

In the same light-emitting group 120 in the same partition, the first electrodes 125 of a plurality of light-emitting elements 12 are connected to the same first voltage lead 151; the second electrodes 126 of light-emitting elements 12 of the same color are connected to the same second voltage lead 152; and the second electrodes 126 of light-emitting elements 12 of different colors are connected to different second voltage leads 152. Here, the first electrode 125 of each light-emitting element 12 may be connected to the first voltage lead 151 through a first electrode lead 161, and the second electrode 126 of each light-emitting element 12 may be connected to the second voltage lead 152 through a second electrode lead 162.

In the same partition, the first voltage leads 151 to which the plurality of light-emitting groups 120 are connected are connected through a first connecting wire 171; among the second voltage leads 152 to which the plurality of light-emitting groups 120 are connected, the second voltage leads 152 to which the light-emitting elements 12 of the same color are connected, are connected through a second connecting wire 172.

For example, each light-emitting group 120 includes a plurality of red light-emitting elements 12r, a plurality of green light-emitting elements 12g, and a plurality of blue light-emitting elements 12b. The plurality of light-emitting elements 12 in each light-emitting group 120 are connected to one first voltage lead 151 and three second voltage leads 152, and the three second voltage leads 152 are respectively referred to as a lead 152A, a lead 152B, and a lead 152C. In the same light-emitting group 120, the first electrodes of the red light-emitting elements 12r, the green light-emitting elements 12g and the blue light-emitting elements 12b are connected to the same first voltage lead 151; the second electrodes of the plurality of red light-emitting elements 12r are connected to the lead 152A; the second electrodes of the plurality of green light-emitting elements 12g are connected to the lead 152B, and the second electrodes of the plurality of blue light-emitting elements 12b are connected to the lead 152C. In the same partition, the first voltage leads 151 to which the plurality of light-emitting groups 120 are connected, are connected to each other through a first connecting wire 171; the leads 152A to which the plurality of light-emitting groups 120 are connected, are connected through a first second-connecting wire 172; the leads 152B to which the plurality of light-emitting groups 120 are connected, are connected through a second second-connecting wire 172; and the leads 152C to which the plurality of light-emitting groups 120 are connected, are connected through a third second-connecting wire 172. In this way, the light-emitting elements 12 of the same color in the same partition can be connected in parallel; and the red light-emitting element 12r, the green light-emitting element 12g, and the blue light-emitting element 12b in the partition can be sequentially turned on by sequentially applying electric signals to the three second connecting wires 172.

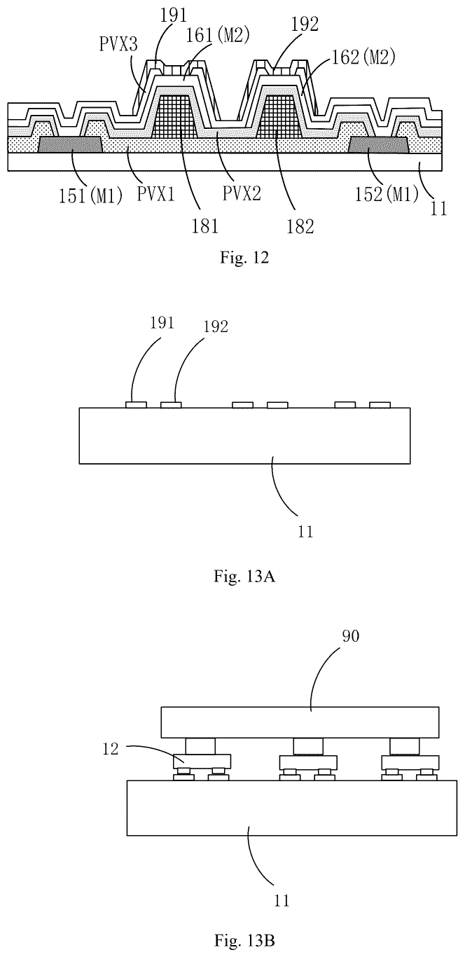

FIG. 12 is a schematic diagram of a drive line layer in a front-mounted light source provided in some embodiments of the present disclosure. The drive line layer is a conductive-line layer connecting the front-mounted light source 10 to the light-emitting element 12. As shown in FIG. 12, a first metal layer M1, a second metal layer M2, a first passivation layer PVX1, a second passivation layer PVX2, a first protrusion 181, a second protrusion 182, a third passivation layer PVX3, a first contact electrode 191 and a second contact electrode 192 are provided on the base substrate 11. The first metal layer M1 includes the above first voltage lead 151 and second voltage lead 152. The first passivation layer PVX1 is provided at a side of the first metal layer M1 away from the base substrate 11. The first protrusion 181 and the second protrusion 182 are located at the side of the first passivation layer PVX1 away from the base substrate 11. The second passivation layer PVX2 is located at the side of the first passivation layer PVX1 away from the base substrate 11 and covers the first protrusion 181 and the second protrusion 182. The second metal layer M2 is arranged at a side of the second passivation layer PVX2 away from the base substrate 11. The second metal layer M2 includes the above first electrode lead 161 and second electrode lead 162, and further includes the first connecting wire 171 and the second connecting wire 172. The first electrode lead 161 is connected to a corresponding first voltage lead 151 via a via hole penetrating the first passivation layer PVX1 and the second passivation layer PVX2. The second electrode lead 162 is connected to a corresponding second voltage lead via a via hole penetrating the first passivation layer PVX1 and the second passivation layer PVX2. The first connecting wire 171 is connected to a corresponding first voltage lead 151 via a via hole penetrating the first passivation layer PVX1 and the second passivation layer PVX2. The second connecting wire is connected to a corresponding second voltage lead 152 via a via hole penetrating the first passivation layer PVX1 and the second passivation layer PVX2. A first contact electrode 191 and a second contact electrode 192 are located at a side of the third passivation layer PVX3 away from the base substrate 11. The first contact electrode 191 is arranged at a position corresponding to the first protrusion 181, and the second contact electrode 192 is arranged at a position corresponding to the second protrusion 182. The first contact electrode 191 is connected to the first electrode lead 161 via a via hole in the third passivation layer PVX3, and the second contact electrode 192 is connected to the second electrode lead 162 via a via hole in the third passivation layer PVX3. The first contact electrode 191 is connected to the first electrode 125 of the light-emitting element 12, and the second contact electrode 192 is connected to the second electrode 126 of the light-emitting element 12.

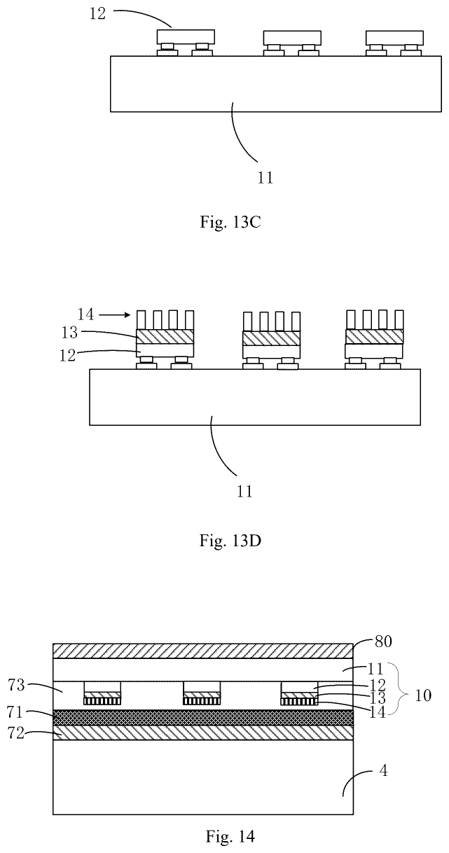

FIGS. 13A-13D are schematic diagrams illustrating fabrication of a front-mounted light source in an embodiment of the present disclosure. As shown in FIGS. 13A to 13D, the manufacturing process of the front-mounted light source 10 includes the following steps.

Step S1: as shown in FIG. 13A, forming a drive circuit layer on a base substrate 11, where the drive circuit layer includes the above respective first voltage lead 151, second voltage lead 152, first connecting wire 171, second connecting wire 171, first electrode lead 161, second electrode lead 162, first contact electrode 191 and second contact electrode 192. Here, only the first contact electrode 191 and the second contact electrode 192 are shown in FIG. 13A.

Step S2: as shown in FIGS. 13B to 13C, transferring a plurality of light-emitting elements 12 onto the base substrate 11 by using a transfer substrate 90, and electrically connecting the first electrode 125 of the light-emitting element 12 to the first contact electrode 191, and electrically connecting the second electrode 126 of the light-emitting element 12 to the second contact electrode 192. Thereafter, the transfer substrate 90 is removed.

Step S3: as shown in FIG. 13D, sequentially forming a first quarter-wave plate 13 and a polarizing layer 14 on the light-emitting element 12.

In some embodiments, orthographic projections of the first quarter-wave plate 13 and the polarizing layer 14 onto the base substrate 11 are both within an orthographic projection of the light-emitting element 12 onto the base substrate 11; that is, the first quarter-wave plate 13 and the polarizing layer 14 are no longer provided in an area where the light-emitting element 12 is not provided. The first quarter-wave plate 13 may be formed by a vapor deposition and etching process. The polarizing layer 14 may be formed by using a nanoimprint process.

One embodiment of the present disclosure further provides a display device. FIG. 14 is a schematic diagram of a display device provided in some embodiments of the present disclosure. As shown in FIG. 14, the display device includes: a reflective display panel 4, a polarizer 80, a second quarter-wave plate 72 and the front-mounted light source 10 in the above embodiment. The front-mounted light source 10, the second quarter-wave plate 72 and the polarizer 80 are all arranged at a display side of the reflective display panel 4, and the second quarter-wave plate 72 is arranged between the front-mounted light source 10 and the reflective display panel 4. A polarization direction of the polarizer 80 is a first polarization direction, and the polarizer 80 is arranged at the side of the front-mounted light source 10 away from the reflective display panel 4.

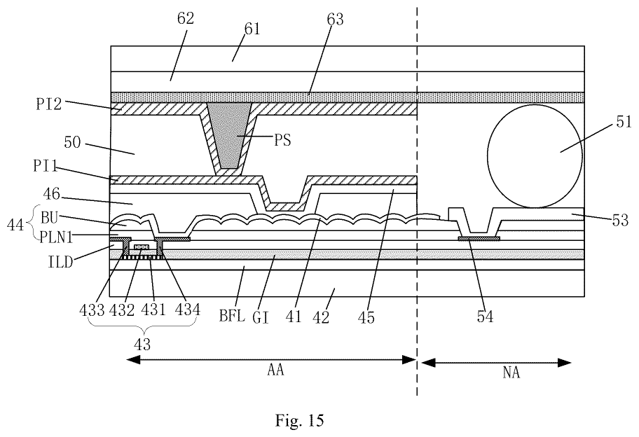

FIG. 15 is a schematic diagram of a reflective display panel provided in some embodiments of the present disclosure. As shown in FIG. 15, the reflective display panel 4 has a display area AA and a non-display area NA. The display area AA includes plurality of pixel regions. The display panel 4 includes: an array substrate and a counter substrate which are oppositely arranged with each other to form a cell, and a liquid crystal layer 50 is located therebetween.

The array substrate includes: a first base 42, a thin-film transistor 43, a first insulating layer, a reflective electrode 41, a second insulating layer 46 and a pixel electrode 45. In addition, the array substrate further includes a plurality of gate lines and a plurality of data lines arranged on the first base 42. The plurality of gate lines and the plurality of data lines are intersected to define a plurality of pixel regions. In each pixel region, there is a thin-film transistor 43, a reflective electrode 41 and a pixel electrode 45.

The thin-film transistor 43 is arranged at a side of the first base 42 facing the liquid crystal layer 50. The thin-film transistor 43 includes an active layer 431, a gate electrode 432, a source electrode 433 and a drain electrode 434. A gate insulating layer GI is provided between the active layer 431 and the gate electrode 432. An interlayer dielectric layer ILD is provided between the layer where the gate electrode 432 is located and the layers where the source electrode 433 and the drain electrode 434 are located. Taking the thin-film transistor 43 being a top gate type thin-film transistor as an example of, as shown in FIG. 15, the active layer 431 is located between the gate electrode 432 and the first base 42. The active layer 431 may include, for example, an inorganic semiconductor material (e.g. polysilicon, amorphous silicon, etc.), an organic semiconductor material, an oxide semiconductor material. The active layer 431 may include a channel region opposite to the gate 432 and source and drain regions respectively provided at two sides of the channel region. Both the source region and the drain region may include an impurity that is higher than the impurity concentration of the channel region. The impurities may include N-type impurities or P-type impurities.

The active layer 431 is covered by the gate insulating layer GI. The gate insulating layer GI may include silicon oxynitride (SiON), silicon oxide (SiOx), silicon nitride (SiNx), silicon oxycarbide (SiOxCy), silicon oxynitride (SiCxNy), aluminum oxide (AlOx), aluminum nitride (AlNx), tantalum oxide (TaOx), hafnium oxide (HfOx), zirconium oxide (ZrOx), titanium oxide (TiOx), etc. The gate insulating layer GIGI1 may be formed as a single layer or multiple layers.

The gate electrode 432 is disposed at a side of the gate insulating layer GI remote from the first base 42. For example, the material of the gate electrode 432 may include gold (Au), alloys of gold, silver (Ag), alloys of silver, aluminum (Al), alloys of aluminum, aluminum nitride (AlNx), tungsten (W), tungsten nitride (WNx), copper (Cu), alloys of copper, nickel (Ni), chromium (Cr), chromium nitride (CrNx), molybdenum (Mo), alloys of molybdenum, titanium (Ti), titanium nitride (TiNx), platinum (Pt), tantalum (Ta), tantalum nitride (TaNx), neodymium (Nd), scandium (Sc), strontium ruthenium oxide (SRO), zinc oxide (ZnOx), tin oxide (SnOx), indium oxide (InOx), gallium oxide (GaOx), indium tin oxide (ITO), indium zinc oxide (IZO), etc. The gate electrode 432 may have a single layer or multiple layers.

The interlevel dielectric layer ILD is provided at a side of the gate electrode 432 away from the first base 42. The interlevel dielectric layer ILD may include silicon oxynitride (SiON), silicon oxide (SiOx), silicon nitride (SiNx), silicon oxycarbide (SiOxCy), silicon oxynitride (SiCxNy), aluminum oxide (AlOx), aluminum nitride (AlNx), tantalum oxide (TaOx), hafnium oxide (HfOx), zirconium oxide (ZrOx), titanium oxide (TiOx), etc. The interlayer dielectric layer ILD may be formed as a single layer or multiple layers.

The source electrode 433 and the drain electrode 434 are provided at a side of the interlayer dielectric layer ILD away from the first base 42. The source electrode 433 is electrically connected to the source region of the active layer 431 through a via hole penetrating the gate insulating layer GI and the interlayer dielectric layer ILD. The drain electrode 434 is electrically connected to the drain region of the active layer 431 through a via hole penetrating the gate insulating layer GI and the interlayer dielectric layer ILD. The materials of the source electrode 433 and the drain electrode 434 may be gold (Au), an alloy of gold, silver (Ag), an alloy of silver, aluminum (Al), an alloy of aluminum, aluminum nitride (AlNx), tungsten (W), tungsten nitride (WNx), copper (Cu), an alloy of copper, nickel (Ni), chromium (Cr), chromium nitride (CrNx), molybdenum (Mo), an alloy of molybdenum, titanium (Ti), titanium nitride (TiNx), platinum (Pt), tantalum (Ta), tantalum nitride (TaNx), neodymium (Nd), scandium (Sc), strontium ruthenium oxide (SRO). Zinc oxide (ZnOx), tin oxide (SnOx), indium oxide (InOx), gallium oxide (GaOx), indium tin oxide (ITO), indium zinc oxide (IZO), etc.

A buffer layer BFL may further be provided between the first base 42 and the active layer 431 of the thin-film transistor 43. The buffer layer BFL may prevent or reduce diffusion of metal atoms and/or impurities from the first base 42 into the active layer 431.

The first insulating layer 44 is provided at a side of the thin-film transistor 43 away from the first base 42. A first via hole corresponding to the drain electrode 434 may be defined in the first insulating layer 44. The first insulating layer 44 may include a first planarization layer PLN1 and a protrusion layer BU. The protrusion layer BU is located at the side of the first planarization layer PLN1 away from the first base 42. A surface of the first planarization layer PLN1 away from the first base 42 is substantially flat. A surface of the protrusion layer BU away from the first base 42 is formed with a plurality of protrusion structures, so that the surface of the protrusion layer BU away from the first base 42 is a concave-convex surface. The first via hole extends through both the first planarization layer PLN1 and the protrusion layer BU. The materials of the first planarization layer PLN1 and the protrusion layer BU may include an organic insulating material including, for example, polyimide, epoxy, acryl, polyester, photoresist, polyacrylate, polyamide, siloxane, and the like. As another example, the organic insulating material includes an elastic material such as urethane, TPU, etc.

The reflective electrode 41 is arranged at the side of the first insulating layer 44 away from the first base 42. The reflective electrode 41 is arranged at the surface of the protrusion layer away from the first base 42, and thus the surface of the reflective layer 124 away from the first base 42 is also formed as a concave-convex surface, so that the light provided by the front-mounted light source 10 can be diffusely reflected, thereby increasing the viewing angle of the reflective display device. Here, the reflective electrode 41 may be a single layer or multiple layers, and in one example, the reflective electrode 41 may include a stack of indium tin oxide (ITO), a metal layer, and indium tin oxide (ITO), where the metal layer is located between two indium tin oxide layers, and the metal layer is, for example, silver (Ag) metal with a relatively high reflectivity.

The second insulating layer 46 is provided at the side of the reflective electrode 41 away from the first base 42. A second via hole corresponding to the reflective electrode 41 is defined in the second insulating layer 46. The pixel electrode is provided at the side of the second insulating layer 46 away from the first base 42 and is connected to the reflective electrode 41 via the second via hole. In one example, orthographic projection of the second via hole onto the first base 42 does not overlap the orthographic projection of the first via hole onto the first base 42, thereby preventing the pixel electrode from breaking within the second via hole.

The second insulating layer 46 may be made of an organic insulating material as described above, and the pixel electrode may be made of a transparent conductive material such as indium tin oxide (ITO), indium zinc oxide (IZO), etc.

The counter substrate includes: a second base 61, and a common electrode 63 provided on the second base 61. The common electrode 63 can be made of the above-mentioned transparent conductive material. The common electrode 63 can be a planar electrode. The counter substrate further includes a spacer PS. The spacer PS is arranged at a side of the common electrode 63 away from the second base 61, and the spacer PS is used for supporting the reflective display panel 4 so as to maintain a certain cell thickness of the reflective display panel 4.

In addition, the counter substrate may further include a black matrix (not shown) provided on the second base 61 and a cover layer 62. The cover layer 62 is located at a side of the black matrix remote from the second base 61, and the common electrode 63 is located at a side of the cover layer 62 remote from the second base 61.

In addition, the reflective display panel 4 further includes a common voltage wire 54, which may be arranged on the array substrate and located in the non-display area NA. The common electrode 63 may be connected to the common voltage wire 54 via a connection piece. The connection piece includes, for example, a gold ball 51 and a connection electrode 53. The connection electrode 53 may be provided in the same layer as the pixel electrode 45, the common voltage wire 54 may be provided in the same layer as the source electrode 433 and the drain electrode 434 of the thin-film transistor 43, and the connection electrode 53 is connected to the common voltage wire 54 via a via hole.

In addition, the display panel 4 further includes a first alignment layer PI1 and a second alignment layer PI2. The first alignment layer PI1 is arranged at a side of the array substrate facing the liquid crystal layer 50. The second alignment layer PI2 is arranged at the side of the counter substrate facing the liquid crystal layer 50. The first alignment layer PI1 and the second alignment layer PI2 are used for aligning liquid crystal molecules in the liquid crystal layer 50. The first alignment layer PI1 and the second alignment layer PI2 cover at least the display area.

In embodiments of the present disclosure, display may be achieved whether the polarizer 80 is disposed between the front-mounted light source 10 and the second quarter-wave plate 72, or on the side of the front-mounted light source 10 facing away from the reflective display panel 4. It is considered that when the polarizer 80 is disposed between the front-mounted light source 10 and the second quarter-wave plate 72, part of the light of the front-mounted light source 10 is reflected between the film layers inside the polarizer 80, resulting in a decrease in contrast of the display device. Therefore, in order to improve the contrast of the display device, in some preferred embodiments of the present disclosure, the polarizer 80 is arranged at the side of the front-mounted light source 10 facing away from the reflective display panel 4, thereby reducing the contrast reduction due to reflection of the polarizer 80.

In some embodiments, as shown in FIG. 14, the display device may further include a half-wave plate (½ wave plate) 71 disposed between the second quarter-wave plate 72 and the front-mounted light source 10. By providing the half-wave plate 71, it is possible to compensate for the difference in the phase modulation capability of the second quarter-wave plate 72 for each wavelength of light. In this way, when the display device achieves a dark state display, no light of any wavelength is emitted from the display device.

The materials of the first quarter-wave plate 13, the second quarter-wave plate 72, and the half-wave plate 71 are not particularly limited in the embodiments of the present disclosure, and in some embodiments, each of the first quarter-wave plate 13, the second quarter-wave plate 72, and the half-wave plate 71 may be made of anisotropic materials, such as cyclo olefin polymer (COP) material or Polycarbonate (PC) material.

In some embodiments, as shown in FIG. 14, the display device further includes an adhesive layer 73 disposed between the front-mounted light source and the half-wave plate 71, thereby adhering the front-mounted light source to the half-wave plate 71.

In one embodiment of the present disclosure, in the front-mounted light source in the display device, a distance between light-emitting elements of the same light-emitting color adjacent in the second direction in the same row is smaller than a distance between the light-emitting elements and the reflective electrode. For example, if the distance between the light-emitting elements and the reflective electrode is 0.6 mm, the distance between adjacent light-emitting elements of the same light-emitting color in the same row in the second direction is less than 0.6 mm, and this arrangement facilitates that the light rays of the light-emitting elements 12 can be uniformly mixed so that the brightness of the emitted light is uniform.

Taking the reflective display panel 4 being in a normally-white mode as an example, the display principle of the display device in FIG. 14 is described below. In the normally-white mode reflective display panel 4, when the liquid crystal layer 50 is not powered, its phase modulation effect on light is equivalent to that of a quarter-wave plate. In the following description, the polarized light of the first polarization direction is TM light and the polarized light of the second polarization direction is TE light.

When achieving a bright-state display, the natural light emitted by the light-emitting element 12 is still natural light after passing through the first quarter-wave plate 13; when the natural light is irradiated to the polarizing layer 14, TM light is transmitted through the polarizing layer 14 and irradiated to the half-wave plate 71, TE light is reflected by the polarizing layer 14; the reflected TE light becomes left-handed circularly polarized light after passing through the first quarter-wave plate 13, the left-handed circularly polarized light becomes right-handed circularly polarized light after being reflected by the reflective layer 124, and the right-handed circularly polarized light becomes TM light after passing through the first quarter-wave plate 13 again, thereby passing through the polarizing layer 14 and irradiating to the half-wave plate 71. After passing through the half-wave plate 71 and the second quarter-wave plate 72, the TM light becomes right-handed circularly polarized light; and after passing through the liquid crystal layer 50, the right-handed circularly polarized light becomes TM light. After the TM light is reflected by the reflective electrode 41, the polarization direction does not change; after the reflected light passes through the liquid crystal layer 50, it becomes right-handed circularly polarized light; and the right-handed circularly polarized light passes through the second quarter-wave plate 72 and the half-wave plate 71 to become TM light, so that the TM light can be emitted through the polarizer 80, thereby achieving the bright-state display.

When achieving a dark-state display, a voltage is applied to the liquid crystal layer 50 so that the liquid crystal layer 50 has no effect on the phase of the light. Meanwhile, the TM light emitted from the front-mounted light source 10 to the half-wave plate 71 passes through the half-wave plate 71 and the second quarter-wave plate 72 and becomes right-handed circularly polarized light; after passing through the liquid crystal layer 50, the right-handed circularly polarized light is reflected by the reflective electrode 41 and becomes left-handed circularly polarized light; after passing through the liquid crystal layer 50, the left-handed circularly polarized light remains unchanged, and then passes through the second quarter-wave plate 72 and the half-wave plate 71 and becomes TE wave, which can be transmit through the polarizer 80, thereby achieving dark state display.

When achieving an intermediate-state display, a voltage is applied to the liquid crystal layer 50 so that a certain deflection occurs. At this time, the TM light emitted by the front-mounted light source 10 towards the half-wave plate 71, after passing through the half-wave plate 71 and the second quarter-wave plate 72, becomes right-handed circularly polarized light; after passing through the liquid crystal layer 50, the right-handed circularly polarized light becomes right-handed elliptically polarized light, and is then reflected by the reflective electrode 41 to become left-handed elliptically polarized light; and after passing through the liquid crystal layer 50, the second quarter-wave plate 72 and the half-wave plate 71, the left-handed elliptically polarized light becomes linearly polarized light, and an angle between the polarization direction of the linearly polarized light and the first polarization direction is greater than 0° and less than 90°, so that a part of the light can be emitted through the polarizer 80 to display a grey-scale picture.

In the embodiment of the present disclosure, by providing the first quarter-wave plate and the polarizing layer 14 on the light-emitting element 12, the transmittance of light of the first polarization direction can be increased to about 80%, and the light efficiency can be increased by about 2 times compared with the display device in FIG. 1. Furthermore, by arranging the polarizer 80 at the side of the front-mounted light source 10 remote from the reflective display panel 4, the contrast ratio of the display device can be increased from 40:1 to 200:1.

It is to be understood that the above embodiments are merely exemplary embodiments used to illustrate the principles of the present invention, but the present invention is not limited thereto. For those of ordinary skill in the art, various modifications and improvements can be made without departing from the spirit and essence of the present invention, and these modifications and improvements are also regarded as the protection scope of the present invention.

1. A front-mounted light source, comprising: a base substrate and a plurality of light-emitting elements on the base substrate;
wherein each of the light-emitting elements comprises a light-emitting layer and a reflective layer, and the reflective layer is between the light-emitting layer and the base substrate; a side of at least one light-emitting element away from the base substrate is provided with a first quarter-wave plate and a polarizing layer; the polarizing layer is at a side of the first quarter-wave plate away from the light-emitting element and is used for transmitting polarized light of a first polarization direction and reflecting polarized light of a second polarization direction; and the first polarization direction intersects the second polarization direction.

2. The front-mounted light source according to claim 1, wherein the polarizing layer is a wire grid polarizing layer.

3. The front-mounted light source according to claim 2, wherein the wire grid polarizing layer comprises a plurality of metal wires arranged side by side; an arrangement cycle of the metal wires is between 60 nm and 14 nm; a height of each of the metal wires is between 160 nm and 300 nm; and a ratio of a line width of each of the metal wires to the arrangement cycle of the metal wires is between 0.5 and 0.7.

4. The front-mounted light source according to claim 1, wherein the light-emitting layer comprises an n-type semiconductor layer, a p-type semiconductor layer and a quantum well layer; the n-type semiconductor layer and the p-type semiconductor layer are both between the quantum well layer and the reflective layer, and the n-type semiconductor layer and the p-type semiconductor layer are both in contact with the quantum well layer;
the first quarter-wave plate is in direct contact with the quantum well layer and the polarizing layer is in direct contact with the first quarter-wave plate.

5. The front-mounted light source according to claim 1, wherein the plurality of light-emitting elements are arranged in a plurality of rows in a first direction, each row comprises a plurality of light-emitting elements arranged in a second direction; the plurality of light-emitting elements in a same row comprise a plurality of light-emitting colors, and the light-emitting colors of a plurality of light-emitting elements arranged in the first direction are the same;
the first direction intersects the second direction.

6. The front-mounted light source according to claim 5, wherein a spacing between two light-emitting elements adjacent in the first direction is 2 to 4 times a spacing between two adjacent light-emitting elements in a same row.

7. The front-mounted light source according to claim 1, wherein the front-mounted light source has a plurality of partitions; a plurality of the light-emitting elements are arranged in each of the partitions; and in a same partition, a plurality of light-emitting elements with a same light-emitting color are connected in parallel.

8. The front-mounted light source according to claim 7, wherein in the same partition, the plurality of light-emitting elements are divided into a plurality of light-emitting groups, the plurality of light-emitting groups are arranged side by side in the first direction, each of the light-emitting groups comprises a plurality of light-emitting elements arranged in the second direction, and the plurality of light-emitting elements in a same light-emitting group comprise a plurality of light-emitting colors;
in a same light-emitting group in the same partition, first electrodes of the plurality of light-emitting elements are connected to a same first voltage lead, second electrodes of light-emitting elements of a same color are connected to a same second voltage lead, and second electrodes of light-emitting elements of different colors are connected to different second voltage leads;
in the same partition, the first voltage leads connected to the plurality of light-emitting groups are connected via a first connecting wire; in the second voltage leads connected to the plurality of light-emitting groups, the second voltage leads connected to the light-emitting elements of a same color are connected via a second connecting wire.

9. The front-mounted light source according to claim 1, wherein orthographic projections of the first quarter-wave plate and the polarizing layer onto the base substrate are both within an orthographic projection of the light-emitting elements onto the base substrate.

10. The front-mounted light source according to claim 1, wherein the polarizing layer is made of aluminum.

11. A display device, comprising: a reflective display panel, a polarizer, a second quarter-wave plate and a front-mounted light source, wherein the front-mounted light source, the second quarter-wave plate and the polarizer are all arranged at a display side of the reflective display panel, the second quarter-wave plate is between the front-mounted light source and the reflective display panel, the polarizer is arranged at a side of the second quarter-wave plate away from the reflective display panel, and a polarization direction of the polarizer is a first polarization direction;
wherein the front-mounted light source comprises: a base substrate and a plurality of light-emitting elements on the base substrate;
wherein each of the light-emitting elements comprises a light-emitting layer and a reflective layer, and the reflective layer is between the light-emitting layer and the base substrate; a side of at least one light-emitting element away from the base substrate is provided with a first quarter-wave plate and a polarizing layer; the polarizing layer is at a side of the first quarter-wave plate away from the light-emitting element and is used for transmitting polarized light of the first polarization direction and reflecting polarized light of a second polarization direction; and the first polarization direction intersects the second polarization direction.

12. The display device according to claim 11, wherein the polarizer is arranged at a side of the front-mounted light source facing away from the reflective display panel.

13. The display device according to claim 11, wherein the display device further comprises a half-wave plate between the front-mounted light source and the second quarter-wave plate.

14. The display device according to claim 11, wherein the reflective display panel comprises: an array substrate and a counter substrate which are arranged opposite to each other to form a cell therebetween, and a liquid crystal layer located therebetween;
the array substrate comprises:
a first base;
a thin-film transistor on a side of the first base facing the liquid crystal layer;
a first insulating layer on a side of the thin-film transistor away from the first base, wherein the first insulating layer is provided with a first via hole corresponding to a drain electrode of the thin-film transistor;
a reflective electrode on a side of the first insulating layer away from the first base, and connected to the drain electrode of the thin-film transistor via the first via hole;
a second insulating layer on a side of the reflective electrode away from the first base, wherein the second insulating layer is provided with a second via hole corresponding to the reflective electrode;
a pixel electrode arranged on a side of the second insulating layer away from the first bas, and connected to the reflective electrode through the second via hole.

15. The display device according to claim 14, wherein a surface of the reflective electrode remote from the first base is concave-convex.

16. The display device according to claim 14, wherein the plurality of light-emitting elements are arranged in a plurality of rows in a first direction, each row comprises a plurality of light-emitting elements arranged in a second direction; the plurality of light-emitting elements in a same row comprise a plurality of light-emitting colors, and the light-emitting colors of a plurality of light-emitting elements arranged in the first direction are the same; the first direction intersects the second direction;
a spacing between two light-emitting elements of a same light-emitting color adjacent in the second direction is smaller than a distance between the light-emitting elements and the reflective electrode.

17. The display device according to claim 11, wherein the polarizing layer is a wire grid polarizing layer.

18. The display device according to claim 17, wherein the wire grid polarizing layer comprises a plurality of metal wires arranged side by side; an arrangement cycle of the metal wires is between 60 nm and 14 nm; a height of each of the metal wires is between 160 nm and 300 nm; and a ratio of a line width of each of the metal wires to the arrangement cycle of the metal wires is between 0.5 and 0.7.

19. The display device according to claim 11, wherein the light-emitting layer comprises an n-type semiconductor layer, a p-type semiconductor layer and a quantum well layer;
the n-type semiconductor layer and the p-type semiconductor layer are both between the quantum well layer and the reflective layer, and the n-type semiconductor layer and the p-type semiconductor layer are both in contact with the quantum well layer;
the first quarter-wave plate is in direct contact with the quantum well layer and the polarizing layer is in direct contact with the first quarter-wave plate.

20. The display device according to claim 11, wherein the plurality of light-emitting elements are arranged in a plurality of rows in a first direction, each row comprises a plurality of light-emitting elements arranged in a second direction; the plurality of light-emitting elements in a same row comprise a plurality of light-emitting colors, and the light-emitting colors of a plurality of light-emitting elements arranged in the first direction are the same;
the first direction intersects the second direction.
